(19) United States
(12) Patent Application Publication
(10) Pub. No.: US 2025/0212882 A1
(43) Pub. Date: Jul. 3, 2025

(54) PESTICIDAL COMPOSITIONS

(71) Applicant: SYNGENTA CROP PROTECTION AG, Basel (CH)

(72) Inventor: Roger AVERY, Bracknell, Berkshire (GB)

(73) Assignee: SYNGENTA CROP PROTECTION AG, Basel (CH)

(21) Appl. No.: 18/867,302

(22) PCT Filed: May 16, 2023
(86) PCT No.: PCT/EP2023/063171

§ 371 Date: Nov. 19, 2024

(30) Foreign Application Priority Data
May 20, 2022 (EP) 22174578.9

(51) Int. Cl. A01N 43/56; A01N 25/02; A01N 43/42; A01P 7/04

(52) U.S. Cl. CPC A01N 43/56; A01N 25/02; A01N 43/42; A01P 7/04

(57) ABSTRACT

A pesticidal composition comprising: (i) 25 to 35% by weight of spiropidion; (ii) 15 to 25% by weight of cyantraniliprole; and (iii) 15 to 30% by weight of 4-O-β-D-galactopyranosyl-α-D-glucopyranose, as a filler component.

The present invention relates to a composition comprising a combination of insecticidal active ingredients, to the preparation of such compositions, and to a method of using such a composition to control pests in crops of useful plants.

Insecticidal compositions containing a combination of the insecticidal active ingredients spiropidion and cyantraniliprole are known, eg, from WO 2013/079564. Such a pesticidal composition is considered to have, for practical purposes, a very advantageous level of activity in controlling insect pests in crops of useful plants, whilst also maintaining acceptable crop safety (phytotoxicity) outcomes. Accordingly, suitable formulated compositions (eg, solid granular) comprising this insecticidal active ingredient combination have been sought.

Amongst a range of other requirements, there is a strong preference for an agrochemical composition (in diluted/dispersed form) for spray application not to leave behind solid residues on the spray application apparatus, eg, nozzles, hoses, tanks, etc, after use. Such deposits make the cleaning of the spray application apparatus more burdensome, and the longer-term accumulation of such residues may in time contaminate future spray applications, or even result in blockages. Likewise, if such a dispersion of an agrochemical composition (eg, a water-dispersible granule) in a spray tank is not evenly distributed or if this feature develops over the longer term due to the poor suspensibility properties of the composition, this can result in uneven application of active ingredient material to a crop field upon application.

Therefore, compositions with (i) substantially residue-free outcomes for the spray application apparatus after use, and with (ii) good suspension properties of the solid-state components and non-volatile ingredients upon dispersion of the composition in a spray tank, are highly desirable.

According to the present invention, there is provided a pesticidal composition comprising:
(i) 25 to 35% by weight of spiropidion;
(ii) 15 to 25% by weight of cyantraniliprole; and
(iii) 15 to 30% by weight of 4-O-β-D-galactopyranosyl-α-D-glucopyranose, as a filler component.

Surprisingly it has been found for the present invention that the use of certain amounts of 4-O-β-D-galactopyranosyl-α-D-glucopyranose as the filler component in pesticidal compositions results in substantially residue-free outcomes on spray application apparatus compared with the use of compositions which contain other conventionally used fillers. As well, the pesticidal compositions of the present invention have been shown to possess beneficial suspensibility properties when diluted for a spray application to a crop.

Further according to the invention, there is provided an aqueous composition comprising the pesticidal composition according to the invention, optionally further comprising one or more adjuvants or carriers.

Still further according to the invention, there is provided a (non-therapeutic) method of combating and controlling pests which comprises applying to a pest, to a locus of a pest, or to a crop of a useful plant susceptible to attack by a pest a composition according to the invention.

Spiropidion ([3-(4-chloro-2,6-dimethyl-phenyl)-8-methoxy-1-methyl-2-oxo-1,8-diazaspiro[4.5]dec-3-en-4-yl] ethyl carbonate. CAS no.: 1229023-00-0) is known inter alia from WO 2010/066780, WO 2018/114648 and WO 2018/114649. Cyantraniliprole (4-bromo-1-(3-chloropyridin-2-yl)-N-[4-cyano-2-methyl-6-(methylcarbamoyl) phenyl]-1H-pyrazole-5-carboxamide. CAS no.: 736994-63-1) is known inter alia from EP 1 599 463. Certain pesticidal mixtures comprising spiropidion and cyantraniliprole as active ingredients are known from WO 2013/079564.

Preferably, the compositions according to the invention comprise as the pesticidal active ingredient component (i) 28 to 32% by weight of spiropidion and (ii) 20 to 25% by weight of cyantraniliprole, and more preferably (i) 29 to 31% by weight of spiropidion and (ii) 21 to 24% by weight of cyantraniliprole. The compositions according to the invention comprise as the pesticidal active ingredient component spiropidion and cyantraniliprole, respectively, in a weight ratio of 1:1 to 7:3, and preferably a weight ratio of 1:1 to 3:2.

Preferably the compositions of the invention comprise 20 to 25% by weight of 4-O-β-D-galactopyranosyl-α-D-glucopyranose of the filler component. 4-O-β-D-galactopyranosyl-α-D-glucopyranose (CAS no.: 63-42-3) may also be referred to as 4-O-β-D-Galactopyranosyl-α-D-glucose or lactose monohydrate.

In preferred embodiments, the compositions of the invention further comprise based on the total weight of the composition (ie, up to 100% by weight):
(iv) 10 to 20% by weight of one or more dispersants;
(v) 1 to 5% by weight of an anti-foaming agent; and
(vi) 5 to 10% by weight of a buffer.

In other preferred embodiments, the compositions of the invention may comprise 1 to 3% by weight of an anti-foaming agent, and preferably 1.5 to 2.5% by weight of an anti-foaming agent.

When a buffering agent component is present in the composition of the invention, there may be included an alkali metal sulfate or an alkaline earth metal sulfate, or else a combination of an alkali metal sulfate and an alkaline earth metal sulfate. Preferably, the alkali metal sulfate used in the compositions of the invention is potassium sulfate or sodium sulfate, and most preferably sodium sulfate. The buffering agent may also include an organic acid, such as citric acid.

Preferably, the composition of the invention is a water-dispersible granule (WG), which may be defined as a solid, granular formulation which can disperse or dissolve quickly when added to water in a spray tank, thus providing a fine particle suspension comprising a pesticidal active ingredient or ingredients. A water-dispersible granule comprising the composition according to the present invention may be prepared according to standard methods. The water-dispersible granule may take the form of an extruded granule or a spray-agglomerated granule.

Preferably, in an aqueous composition according to the invention (eg, a tank mix preparation for applying to a crop), the adjuvant is selected from a mineral oil, a vegetable oil, an esterified vegetable oil, a methylated vegetable oil or an alkyl ester phosphate-based adjuvant. A pesticide adjuvant may be defined as a substance present in a pesticidal composition (eg, a concentrated active ingredient formulation diluted in water in a tank for a foliar spray application on a crop), which improves pesticidal active ingredient performance, for example by facilitating the spreading of the active ingredient on a leaf surface or penetration into the leaf of the crop plant.

Examples of adjuvant classes, which may be used in accordance with the present invention include a mineral oil, a vegetable oil, an esterified vegetable oil, a methylated vegetable oil or an alkyl ester phosphate-based adjuvant. Commercially-available adjuvant products which may be tank-mixed to yield a spray fomulation with the composition of the present invention include HASTEN™ (Victorian Chemical Co. Pty. Ltd.—blend of an esterified vegetable oil and non-ionic surfactants), OCHIMA® (Syngenta—alkyl ester of phosphoric acid (EC formulation)), LEDNA™ (Polaquimia—EC formulation comprising a methyl ester of soybean oil), Atplus® 463 (CRODA Europe Limited—60% parafin oil with surfactant blend), Actirob® B (Bayer AG-rapeseed oil methyl ester (esterified vegetable oil)), Destiny® HC (Winfield Solutions LLC-methylated soybean oil), DYNE-AMIC® (HELENA—blend of (methylated) vegetable oil and organosilicone-based nonionic surfactants), and FS Optique™ (GROWMARK, Inc—methyl ester of canola oil).

A dispersant or a dispersing agent is typically a surfactant substance, which when added to a suspension of solid particles in a liquid better enables the separation of the particles to avoid their settling or clumping together. Dispersants which may be used in accordance with the present invention include, but are not limited to, lignosulphonate salts (eg, Ufoxane 3A, Borregard AS; Borresperse NA, Borregard AS; Polyfon™ H, Ingevity; Marasperse CBOS-4 powder, LignoTech), naphthalene sulfonic acid salts (eg, Dispergator B Gran, TFL Ledertechnik GmbH), a co-polymer of 2,5-furandione and 2,4,4-trimethylpentene (eg, Geropon® Ta/72, Solvay).

An anti-foaming agent is a chemical additive that reduces and hinders the formation of foam in a composition, such as a pesticidal formulation. Anti-foaming agents which may be used in accordance with the present invention include, but are not limited to, polydimethylsiloxanes (eg, XIAMETER™ ACP-1500, Dow, Inc; Antifoam MSA, Univar; Xiameter ACP-0001, Dow Brasil; Xiameter ACP-0100, Dow Chemical).

In addition to 4-O-β-D-galactopyranosyl-α-D-glucopyranose, minor amounts of other conventional fillers may be used in accordance with the present invention. Preferably, the filler component of the compositions does not comprise a diatomaceous earth material (eg, Ceilte™), or the compositions comprise less than 10% by weight, or less than 5% by weight, of a diatomaceous earth material as filler.

Examples of pests which may be controlled in accordance with the compositions of the present invention include those:
from the order Acarina, for example, Acalitus spp, Aculus spp, Acaricalus spp, Aceria spp, Acarus siro, Amblyomma spp., Argas spp., Boophilus spp., Brevipalpus spp., Bryobia spp, Calipitrimerus spp., Chorioptes spp., Dermanyssus gallinae, Dermatophagoides spp, Eotetranychus spp, Eriophyes spp., Hemitarsonemus spp, Hyalomma spp., Ixodes spp., Olygonychus spp, Ornithodoros spp., Polyphagotarsone latus, Panonychus spp., Phyllocoptruta oleivora, Phytonemus spp, Polypha-gotarsonemus spp, Psoroptes spp., Rhipicephalus spp., Rhizoglyphus spp., Sarcoptes spp., Steneotarsonemus spp, Tarsonemus spp. and Tetranychus spp.;
from the order Anoplura, for example, Haematopinus spp., Linognathus spp., Pediculus spp., Pemphigus spp. and Phylloxera spp.;
from the order Coleoptera, for example, Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Liogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popillia spp., Psylliodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.;
from the order Diptera, for example, Aedes spp., Anopheles spp, Antherigona soccata, Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.;
from the order Hemiptera, for example, Acanthocoris scabrator, Acrosternum spp, Adelphocoris lineolatus, Amblypelta nitida, Bathycoelia thalassina, Blissus spp, Cimex spp., Clavigralla tomentosicollis, Creontiades spp, Distantiella theobroma, Dichelops furcatus, Dysdercus spp., Edessa spp, Euchistus spp., Eurydema pulchrum, Eurygaster spp., Halyomorpha halys, Horcias nobilellus, Lep-tocorisa spp., Lygus spp, Margarodes spp, Murgantia histrionic, Neomegalotomus spp, Nesidiocoristenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp, Triatoma spp., and Vatiga illudens;
from the order Homoptera, for example, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aonidiella auranti, Aphididae, Aphis spp., Aspidiotus spp., Aulacorthum solani, Bactericera cockerelli, Bemisia spp, Brachycaudus spp, Brevicoryne brassicae, Cacopsylla spp, Cavariella aegopodii Scop., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockerelli, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, and Zyginidia scutellaris;
from the order Hymenoptera, for example, Acromyrmex, Arge spp, Atta spp., Cephus spp., Diprion spp., Diprionidae, Gilpinia polytoma, Hoplocampa spp., Lasius spp., Monomorium pharaonis, Neodiprion spp., Pogonomyrmex spp, Slenopsis invicta, Solenopsis spp. and Vespa spp.;
from the order Isoptera, for example, Coptotermes spp, Corniternes cumulans, Incisitermes spp, Macrotermes spp, Mastotermes spp, Microtermes spp, Reticulitermes spp.; Solenopsis geminate;
from the order Lepidoptera, for example, Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Orniodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.;
from the order Mallophaga, for example, Damalinea spp. and Trichodectes spp.;
from the order Orthoptera, for example, Blatta spp., Blattella spp., Gryllotalpa spp., Leucophaea maderae, Locusta spp., Neocurtilla hexadactyla, Periplaneta spp., Scapteriscus spp, and Schistocerca spp.;
from the order Psocoptera, for example, Liposcelis spp.;
from the order Siphonaptera, for example, Ceratophyllus spp., Ctenocephalides spp. and Xenopsylla cheopis;
from the order Thysanoptera, for example, Calliothrips phaseoli, Frankliniella spp., Heliothrips spp, Hercinothrips spp., Parthenothrips spp, Scirtothrips aurantii, Sericothrips variabilis, Taeniothrips spp., Thrips spp; and/or
from the order Thysanura, for example, Lepisma saccharina.

Examples of soil-inhabiting pests, which can damage a crop in the early stages of plant development, are:
from the order Lepidoptera, for example, Acleris spp., Aegeria spp., Agrotis spp., Alabama argillaceae, Amylois spp., Autographa spp., Busseola fusca, Cadra cautella, Chilo spp., Crocidolomia binotalis, Diatraea spp., Diparopsis castanea, Elasmopalpus spp., Heliothis spp., Mamestra brassicae, Phthorimaea operculella, Plutella xylostella, Scirpophaga spp., Sesamia spp., Spodoptera spp. and Tortrix spp.;
from the order Coleoptera, for example, Agriotes spp., Anthonomus spp., Atomaria linearis, Chaetocnema tibialis, Conotrachelus spp., Cosmopolites spp., Curculio spp., Dermestes spp., Diabrotica spp., Dilopoderus spp., Epilachna spp., Eremnus spp., Heteronychus spp., Lissorhoptrus spp., Melolontha spp., Orycaephilus spp., Otiorhynchus spp., Phlyctinus spp., Popillia spp., Psylliodes spp., Rhizopertha spp., Scarabeidae, Sitotroga spp., Somaticus spp., Tanymecus spp., Tenebrio spp., Tribolium spp., Trogoderma spp. and Zabrus spp.;
from the order Orthoptera, for example, Gryllotalpa spp.;
from the order Isoptera, for example, Reticulitermes spp.;
from the order Psocoptera, for example, Liposcelis spp.;
from the order Anoplura, for example, Haematopinus spp., Linognathus spp., Pediculus spp., Pemphigus spp. and Phylloxera spp.;
from the order Homoptera, for example, Eriosoma larigerum;
from the order Hymenoptera, for example, Acromyrmex, Atta spp., Cephus spp., Lasius spp., Monomorium pharaonis, Neodiprion spp., Solenopsis spp. and Vespa spp.;
from the order Diptera, for example, Tipula spp.;
crucifer flea beetles (Phyllotreta spp.), root maggots (Delia spp.), cabbage seedpod weevil (Ceutorhynchus spp.) and aphids.

In particular, the compositions of the invention may be applied against insects from the order Homoptera (in particular, white flies, aphids, psyllids and armoured and soft scales), Thysanoptera (Thrips), Acarina (mites) and Lepidoptera (butterflies and moths, and larva thereof). Preferably, the compositions of the invention may be applied against white flies, aphids, Thrips, in particular, silverleaf whitefly (Bemisia tabaci), greenhouse whitefly (Trialeurodes vaporariorum), western flower Thrips (Frankliniella occidentalis), onion Thrips (Thrips tabaci), tomato Thrips (Frankliniella schultzei), jassid, melon Thrips (Thrips palmi), cluster caterpillar (Spodoptera litura) and potato moth (Phthorimaea operculella).

Crops of useful plants in which the compositions according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, watermelon, okra, onion, leek, pepper, potato, pumpkin, squash, rhubarb, spinach and tomato; and vines for example grapes. The compositions of the invention can also be applied on turf, lawn and pastures.

Preferably, the compositions of the invention may be applied to a crop of a useful plant selected from:
the order Solanacea (including tomato, potato, aubergine, chilli, pepper, tobacco);
the order Cucurbitaceae (including squash, pumpkin, watermelon, melon, cucumber);
the order Alliaceae (including onion, garlic, leek);
the order Asparagacea (including asparagus)
the order Brassicaceae (including broccoli, cauliflower, cabbage).

Preferably, the composition of the invention may be applied to a crop of a useful plant selected from cotton, cucumber, tomato, pepper, chili, broccoli, cauliflower, cabbage.

In some embodiments of the method of the invention, applying the composition is to the soil (or other growth substrate) of the crop of the useful plant by drip, drenching or injection.

The rate at which the agrochemical compositions of the invention are applied will depend upon the particular type of insect, etc, to be controlled, the degree of control required and the timing and method of application and can be readily determined by the person skilled in the art. In general, the compositions of the invention can be applied at an application rate of between 0.005 kilograms/hectare (kg/ha) and about 5.0 kg/ha, based on the total amount of active ingredient in the composition. An application rate of between about 0.1 kg/ha and about 1.5 kg/ha is preferred, with an application rate of between about 0.3 g/ha and 0.8 kg/ha being especially preferred.

The pesticidal compositions of the present invention may be used as an insecticide to control pests on cotton plants, in particular for the control of insects from the order Homoptera (in particular, white flies, aphids, psyllids and armoured and soft scales), Thysanoptera (Thrips) and Acarina (mites).

The pesticidal compositions of the present invention may be used as an insecticide to control pests on cotton plants, in particular for the control of insects from the order Homoptera (in particular, white flies, aphids, psyllids and armoured and soft scales), Thysanoptera (Thrips) and Acarina (mites).

In particular, transgenic cotton events expressing useful traits which may be used in combination with the compositions of the invention, include BXN10211, BXN10215, BXN10222, BXN10224, COT102, COT67B, GHB614, GHB119, LLCotton25, MON531, MON757, MON15985, MON1445, MON88913, MON1076, MON1698, MON88701, T304-40, 281-24-236, 3006-210-23, 31707, 31803, 31808, 42317, and the like. Such combinations of the compositions of the invention with cotton events expressing one or more useful traits may provide more durable yield protection, provide a resistance management strategy for target pest control, and reduce farmer inputs, saving considerable expense in time and monetary value.

In an aqueous composition comprising the pesticidal composition according to the invention (eg, a tank-mix composition) there may be added a further component comprising a pesticidal active ingredient selected from one or more of:

Abamectin, Acequinocyl, Acetamiprid, Acetoprole, Acrinathrin, Acynonapyr, Afidopyropen, Afoxalaner, Alanycarb, Allethrin, Alpha-Cypermethrin, Alphamethrin, Amidoflumet, Aminocarb, Azocyclotin, Bensultap, Benzoximate, Benzpyrimoxan, Betacyfluthrin, Beta-cypermethrin, Bifenazate, Bifenthrin, Binapacryl, Bioallethrin, Bioallethrin S)-cyclopentylisomer, Bioresmethrin, Bistrifluron, Broflanilide, Brofluthrinate, Bromophos-ethyl, Buprofezine, Butocarboxim, Cadusafos, Carbaryl, Carbosulfan, Cartap, CAS number: 1472050 Apr. 6, CAS number: 1632218-00-8, CAS number: 1808115-49-2, CAS number: 2032403-97-5, CAS number: 2044701-44-0, CAS number: 2128706 May 6, CAS number: 2249718-27-0, Chlorantraniliprole, Chlordane, Chlorfenapyr, Chloroprallethrin, Chromafenozide, Clenpirin, Cloethocarb, Clothianidin, 2-chlorophenyl N-methylcarbamate (CPMC), Cyanofenphos, Cyclaniliprole, Cyclobutrifluram, Cycloprothrin, Cycloxaprid, Cycloxaprid, Cyenopyrafen, Cyetpyrafen (or Etpyrafen), Cyflumetofen, Cyfluthrin, Cyhalodiamide, Cyhalothrin, Cypermethrin, Cyphenothrin, Cyproflanilide, Cyromazine, Deltamethrin, Diafenthiuron, Dialifos, Dibrom, Dicloromezotiaz, Diflovidazine, Diflubenzuron, dimpropyridaz, Dinactin, Dinocap, Dinotefuran, Dioxabenzofos, Emamectin, Empenthrin, Epsilon-momfluorothrin, Epsilon-metofluthrin, Esfenvalerate, Ethion, Ethiprole, Etofenprox, Etoxazole, Famphur, Fenazaquin, Fenfluthrin, Fenitrothion, Fenobucarb, Fenothiocarb, Fenoxycarb, Fenpropathrin, Fenpyroxymate, Fensulfothion, Fenthion, Fentinacetate, Fenvalerate, Fipronil, Flometoquin, Flonicamid, Fluacrypyrim, Fluazaindolizine, Fluazuron, Flubendiamide, Flubenzimine, Flucitrinate, Flucycloxuron, Flucythrinate, Fluensulfone, Flufenerim, Flufenprox, Flufiprole, Fluhexafon, Flumethrin, Fluopyram, Flupyradifurone, Flupyrimin, Fluralaner, Flupentiofenox, Fluvalinate, Fluxametamide, Fosthiazate, Gamma-Cyhalothrin, Gossyplure™, Guadipyr, Halofenozide, Halofenozide, Halofenprox, Heptafluthrin, Hexythiazox, Hydramethylnon, Imicyafos, Imidacloprid, Imiprothrin, Indoxacarb, lodomethane, Iprodione, Isocycloseram, Isothioate, Ivermectin, Kappa-bifenthrin, Kappa-tefluthrin, Lambda-Cyhalothrin, Lepimectin, Lufenuron, Metaflumizone, Metaldehyde, Metam, Methomyl, Methoxyfenozide, Metofluthrin, Metolcarb, Mexacarbate, Milbemectin, Momfluorothrin, nicofluprole Niclosamide, Nitenpyram, Nithiazine, Omethoate, Oxamyl, Oxazosulfyl, Parathion-ethyl, Permethrin, Phenothrin, Phosphocarb, Piperonylbutoxide, Pirimicarb, Pirimiphos-ethyl, Polyhedrosis virus, Prallethrin, Profenofos, Profenofos, Profluthrin, Propargite, Propetamphos, Propoxur, Prothiophos, Protrifenbute, Pyflubumide, Pymetrozine, Pyraclofos, Pyrafluprole, Pyridaben, Pyridalyl, Pyrifluquinazon, Pyrimidifen, Pyrimostrobin, Pyriprole, Pyriproxyfen, Resmethrin, Sarolaner, Selamectin, Silafluofen, Spinetoram, Spinosad, Spirodiclofen, Spiromesifen, Spirotetramat, Sulfoxaflor, Tebufenozide, Tebufenpyrad, Tebupirimiphos, Tefluthrin, Temephos, Tetrachloraniliprole, Tetradiphon, Tetramethrin, Tetramethylfluthrin, Tetranactin, Tetraniliprole, Theta-cypermethrin, Thiacloprid, Thiamethoxam, Thiocyclam, Thiodicarb, Thiofanox, Thiometon, Thiosultap, Tioxazafen, Tolfenpyrad, Toxaphene, Tralomethrin, Transfluthrin, Triazamate, Triazophos, Trichlorfon, Trichloronate, Trichlorphon, Triflumezopyrim, Tyclopyrazoflor, Zeta-Cypermethrin.

As already indicated, the pesticidal compositions of the present invention have, for practical purposes, a very advantageous level of activity in controlling insect pests in crops of useful plants after foliar or soil application, whilst also maintaining acceptable crop safety (phytotoxicity) outcomes. Further, the compositions of the present invention when in an agrochemical formulation may possess any number of other benefits compared to other compositions including, inter alia, the prevention of sedimentation, thickening, phase separation, cloudiness, foaming or crystal growth, chemical stability of the active ingredients (degradation), long-term formulation stability (eg, at high temperature, such as 45° C.), and spray drift.

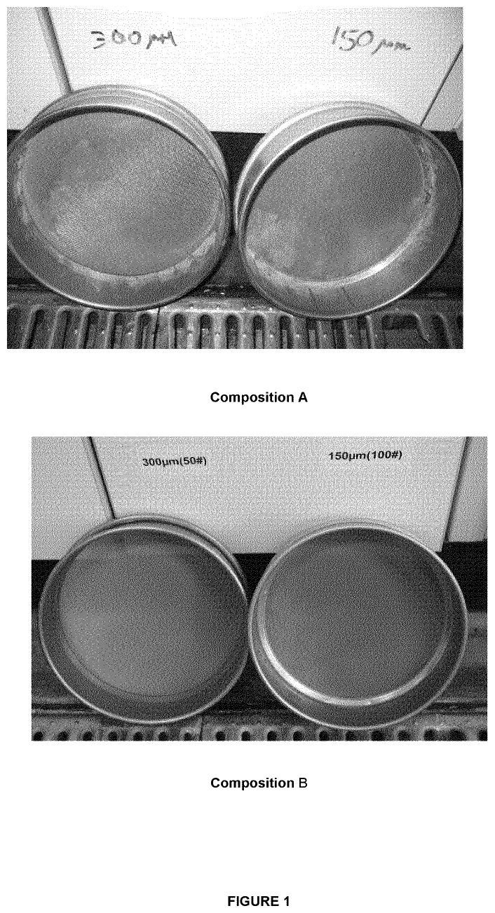

FIG. 1 shows sieve (300 μm and 150 μm) residues of drainings from Compositions A and B as described according to the method outlined in the below residue study (i).

### EXAMPLES

The Examples which follow serve to illustrate the invention and in particular demonstrate the surprising effect of the use of specific amounts of 4-O-β-D-galactopyranosyl-α-D-glucopyranose in compositions according to the invention in:
(i) minimising solid residue deposits on surfaces such as in nozzle filters, spray tanks (including a knapsack sprayer), etc, used in the application of a pesticidal composition to a crop; and
(ii) improving the suspensibility of a water-disperable granule composition once dispersed in a bulk water volume for application to a crop.

4-O-β-D-galactopyranosyl-α-D-glucopyranose (CAS no.: 63-42-3), otherwise known as (+)-lactose is commercially available, eg, as PHARMATOSE 200M (DFE Pharma International, Germany). Celite™ 209 (CAS no.: 61790-53-2) is commercially available from a range of sources, eg, Celite France, France.

Referring to Table 1 below, Composition A is a composition as a water-dispersible granule not according to the invention (including a Celite™ (diatomaceous earth) filler) and Composition B is a composition as a water-dispersible granule according to the invention (with no Celite™ filler present). Composition A and Composition B are otherwise substantially the same, with the exception of the inclusion of additional lactose filler at the expense of Celite™ 209 in Composition B.

The composition according to the present invention (Composition B) and as a comparative example (Composition A) are prepared according to known formulation methods for a water-dispersible (wettable) granule using a 0.6 mm diameter basket extruder.

TABLE 1

| | Composition A | Composition B |
|---|---|---|
| | (% by weight) | (% by weight) |
| | Comparative | According to |
| Component | example | the invention |
| Spiropidion | 30 | 30 |
| Cyantraniliprole | 22.5 | 22.5 |
| Dispersant mixture | 15 | 15 |
| (lignosulphonate salt & | | |
| naphthalene sulfonic acid salt) | | |
| Buffer mixture | 7 | 7 |
| (alkali metal sulfate & organic acid) | | |
| Surfactant | 2 | 2 |
| (co-polymer of 2,5-furandione and | | |
| 2,4,4-trimethylpentene) | | |
| Anti-foaming agent (Antifoam MSA) | 2 | 2 |
| Filler (PHARMATOSE 200M) | 10.5 | 21.5 |
| Filler (Celite ™ 209) | 11 | — |

### (i) Residue Study

A knapsack spray test using a Cooper Pegler 3 Knapsack sprayer was carried out on Compositions A and B (80 g product in 20 L) to assess performance in terms of residue formation at spray completion and cleaning. In separate experiments, the sprayer tank was half-filled with water (10 L), then composition A or B (80 g) added to the tank which was agitated gently to disperse the granular compositions. The tank was filled (20 L) and the contents further agitated prior to the commencement of a spray application. At the end of the spraying process when the tank was emptied, the drainings (water to rinse and clean the knapsack apparatus) were visually assessed.

In particular, the drainings were filtered through 150 μm and 300 μm sieves (see FIG. 1). For composition A, as can be clearly seen in FIG. 1, some white solid residue was observed that was not apparent (or at a very low level) for the drainings of the test using composition B. It is to be noted, that the Celite™ material comprised in Composition A has an average particle diameter in the range of about 10 to 15 μm, significantly less than the sieve pore diameter.

These enhanced spray application properties for the composition according to the invention leading to almost no residues is considered unusual for an extruded water-dispersible granule. A possible explanation for this observation may be that residue formation results from the Celite™ 209 component of Composition A absorbing some of the dispersant/surfactant component of the composition.

### (ii) Suspensibility Study

Suspensibility of Compositions A and B is defined in the present example as the percentage of solid particles and non-volatile ingredients remaining in suspension after a defined time period standing in a cylindrical column of water (250 mL) at 30° C. (initial suspensibility analysis). In the present example, the water-dispersible granules of Compositions A and B were tested at a 1% w/v dilution in water.

At the end of the 30-minute standing period, the top 9/10^{th} (225 mL) of the test sample volume was drawn off avoiding turbulence and discarded. The remaining 1/10^{th} (25 mL) was retained and the suspensibility determined by routine gravimetric analysis by evaporating water from the sample, weighing the dried sample and then calculating the suspensibility percentage based on the observed weight versus expected weight for an optimal suspensibility, ie, 10% of the original weight of Compositions A and B. Tests were also conducted in accordance with this procedure with standing of the suspensions for 2 weeks at 54° C. and for 8 weeks at 40° C.

The higher the suspensibility percentage (see Table 2), the better performed the composition in terms of an even distribution of the solid particles and non-volatile ingredients throughout the volume of the sample (ie, 100%=optimal suspension. 0%=settled and no suspension/fully settled contents).

TABLE 2

| | After time (weeks) at | |
|---|---|---|
| Composition | temperature (° C.) | Suspensibility (%) |
| A | Initial | 59 |
| A | 2 weeks at 54° C. | 57 |
| A | 8 weeks at 40° C. | 58 |
| B | Initial | 95 |
| B | 2 weeks at 54° C. | 96 |
| B | 8 weeks at 40° C. | 96 |

It is clear from the suspensibility data in Table 2 that Composition B according to the invention has far superior suspensibility properties to Composition A.

1. A pesticidal composition comprising:
(i) 25 to 35% by weight of spiropidion;
(ii) 15 to 25% by weight of cyantraniliprole; and
(iii) 15 to 30% by weight of 4-O-b-D-galactopyranosyl-a-D-glucopyranose, as a filler component.

2. The pesticidal composition according to claim 1, comprising:
(i) 28 to 32% by weight of spiropidion; and
(ii) 20 to 25% by weight of cyantraniliprole.

3. The pesticidal composition according to claim 1, comprising:
(iii) 20 to 25% by weight of 4-O-b-D-galactopyranosyl-a-D-glucopyranose.

4. The pesticidal composition according to claim 1, wherein the filler component comprises less than 5% by weight of a diatomaceous earth material (eg, Celite™), or does not comprise a diatomaceous earth material.

5. The pesticidal composition according to claim 1, further comprising:
(iv) 10 to 20% by weight of one or more dispersants;
(v) 1 to 5% by weight of an anti-foaming agent; and
(vi) 5 to 10% by weight of a buffer.

6. The composition according to claim 1, further comprising one or more additional ingredients selected from wetting agents, biocides, stabilizers and pigments.

7. The pesticidal composition according to claim 1, further comprising an additional insecticidal active ingredient.

8. The pesticidal composition according to claim 1, which is a water-disperable granule.

9. An aqueous composition comprising the pesticidal composition according to claim 1, optionally further comprising one or more adjuvants or carriers.

10. The aqueous composition according to claim 9, wherein the adjuvant is selected from a mineral oil, a vegetable oil, an esterified vegetable oil, a methylated vegetable oil or an alkyl ester phosphate-based adjuvant.

11. A method of combating and controlling pests which comprises applying to a pest, to a locus of a pest, or to a crop of a useful plant susceptible to attack by a pest, a composition according to claim 1.

12. The method according to claim 11, wherein the pest is selected from the order Homoptera, Thysanoptera, Acarina or Lepidoptera.

13. The method according to claim 12, wherein the pest is selected from white flies, aphids, Thrips.

14. The method according to claim 11, wherein the plant is selected from:
(i) cotton; or
(ii) fruit and vegetables, in particular Cucurbita, Brassicaceae or Solanaceae, and preferably the plant is selected from cotton, cucumber, tomato, pepper, chili, broccoli, cauliflower, cabbage.

15. The method according to claim 11, wherein applying the composition is to the soil of the crop of the useful plant by drip, drenching or injection.
